(19) United States
(12) Patent Application Publication
(10) Pub. No.: US 2024/0403627 A1
(43) Pub. Date: Dec. 5, 2024

(54) METHOD AND APPARATUS FOR CHARACTERIZING CULTURAL SYMBOLS

(71) Applicant: Xu Yuan, Kowloon City (HK)

(72) Inventor: Xu Yuan, Kowloon City (HK)

(21) Appl. No.: 18/326,993

(22) Filed: May 31, 2023

(51) Int. Cl. G06N 3/08

(52) U.S. Cl. CPC G06N 3/08

(57) ABSTRACT

The present disclosure proposes a method for characterizing cultural symbols by using a machine learning model, including: receiving multiple materials about a symbol unit, wherein the multiple materials at least include a picture drawing the symbol unit, pronunciation of the symbol unit, and an image or a video showing cultural meaning of the symbol unit, and the symbol unit is a single cultural symbol or a combination of multiple cultural symbols; for each material of the multiple materials, analyzing and learning the material to extract features of the material to form a set of feature vectors; fusing all of the formed feature vectors into a tensor; and analyzing and learning the tensor to generate a concept vector characterizing the symbol unit, wherein the concept vector is directly and consistently associated with the symbol unit. The method can characterize a broader range of cultural symbols, and can be used for multimodal information retrieval.

### TECHNICAL FIELD

The non-limiting and example embodiments of the present disclosure generally relate to the technical field of machine learning, and specifically to method and apparatus for characterizing cultural symbols by using a machine learning model.

### BACKGROUND

This section introduces aspects that may facilitate a better understanding of the disclosure. Accordingly, the statements of this section are to be read in this light and are not to be understood as admissions about what is in the prior art or what is not in the prior art.

Machine learning is a technology that makes model assumptions for research problems, uses computers to learn model parameters from training data, and ultimately predicts and analyzes data. Machine learning model is the core component of the machine learning.

Essentially, a machine learning model can be seen as a function that receives data as input and generates output. A kind of machine learning model contains internal parameters and calculates on the input based on the internal parameters to generate the output. Another kind of machine learning model is a deep learning model, which has multiple layers of machine learning models stacked together to process the input and generate the output, for example, the deep neural network used by the deep learning model contains an input layer, an output layer, and one or more hidden layers between the input layer and output layer, where each layer performs nonlinear transformation on its input and generates its output.

Nowadays, to bring more convenience to people's life, various technologies have emerged that use machine learning to process human cultural symbols such as texts. For example, FastText is a fast text classifier developed by Facebook and providing a simple and efficient method of text classification and representation learning, and it uses a machine learning model to analyze the structure and correlation between letters to encode English words digitally, but cannot be applied to hieroglyphs. As another example, Google's VisualRank technology uses machine learning models to analyze the correlation between images and text on the same website page, and can search for images that appear on the same website page based on the text, but cannot use descriptions of the images themselves as search keywords to find the images.

In addition, currently there are also machine learning solutions for processing human cultural symbols that are disclosed in the following patent (application) documents.

The solution in the document with patent number U.S. Pat. No. 10,621,420B2 can convert an image into a digital code, which is directly and consistently associated with the image and differs from the corresponding digital codes of other images. This solution can be applied for extraction of the visual features of cultural symbols, but it cannot represent the cultural meaning of symbols and the interrelationships between symbols.

The solution in the document with patent number U.S. Pat. No. 9,779,085B2 can convert a text into a digital code, which is directly and consistently associated with the text and differs from the corresponding digital codes of other texts. This solution can be applied for the structure and correlation analysis of a symbol system, but the digital code cannot represent the cultural meaning of a symbol itself.

The solution in the document with patent number U.S. Pat. No. 10,635,949B2 can convert the text in the image into a digital code, which is directly and consistently associated with the text and differs from the digital codes of other texts, but only limited to the visual features of the text.

The solution in the document with public number U.S. Pat. No. 20,200,342183A1 can use machine learning models to process text sequences and generate meaningful text sequences as responses. Although this solution is based on the textual structure and correlation analysis of symbols, it does not involve visual and auditory processing of symbols.

The solution in the document with the public number CN106909625A can convert the text in the image into a digital code, which has a direct and consistent association with the text and is different from the digital codes of other texts, and can be used for image-to-image retrieval. This solution does not involve auditory processing of symbols either.

### SUMMARY

To resolve or alleviate at least one of the above problems, the inventors of the present disclosure conceive of a solution for processing human cultural symbols by using a machine learning model to generate concept vectors containing cultural meanings of the symbols for use in e.g. artificial intelligence applications such as sequence conversion and symbol understanding.

According to a first aspect of the present disclosure, the object is achieved by a method for characterizing cultural symbols by using a machine learning model, including: receiving multiple materials about a symbol unit, wherein the multiple materials at least include a picture drawing the symbol unit, pronunciation of the symbol unit, and an image or a video showing cultural meaning of the symbol unit, and the symbol unit is a single cultural symbol or a combination of multiple cultural symbols; for each material of the multiple materials, analyzing and learning the material to extract features of the material to form a set of feature vectors; fusing all of the formed feature vectors into a tensor; and analyzing and learning the tensor to generate a concept vector characterizing the symbol unit, wherein the concept vector is directly and consistently associated with the symbol unit.

According to a second aspect of the present disclosure, the object is achieved by a machine, comprising: a processor; and a memory, having stored instructions that when executed by the processor cause the machine to perform the method according to the first aspect.

According to a third aspect of the present disclosure, the object is achieved by a machine readable medium having stored thereon instructions that when executed on a machine cause the machine to perform the method according to the first aspect.

The concept vectors obtained by the digital encoding of cultural symbols in the solution of the present disclosure implies multiple features including e.g. the visual features, auditory features, grammatical features, part of speech of the symbols, and can characterize the cultural meanings of the symbols themselves and the mutual relationship between the symbols. Therefore, the solution of the present disclosure can characterize a broader range of cultural symbols, such as hieroglyphs, literal symbols, mathematical symbols, logical symbols, trademarks, flags, political symbols, literal words, literal abbreviations, mathematical formulas, logical representations and so on, and can be used for multimodal information retrieval such as image to image, text to image, image to text, text to sound, text to video and so on.

### BRIEF DESCRIPTION OF THE DRAWINGS

The above and other aspects, features, and benefits of the present disclosure will become more fully apparent from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of the method according to the present disclosure;

FIG. 2 shows formation of feature vectors and a tensor in an exemplary processing of the method according to the present disclosure;

FIG. 3 shows generation of a concept vector in the exemplary processing of the method according to the present disclosure;

FIG. 4 illustrates inference of feature vectors and generation of another concept vector when one or two materials are missing in the exemplary processing of the method according to the present disclosure;

FIG. 5 illustrates significant difference between concept vectors in a vector space in the exemplary processing of the method according to the present disclosure;

FIG. 6 shows generation of a further concept vector in the exemplary processing of the method according to the present disclosure;

FIG. 7 is a schematic block diagram of a machine according to the present disclosure.

### DETAILED DESCRIPTION

Embodiments herein will be described more fully hereinafter with reference to the accompanying drawings. The embodiments herein may, however, be embodied in many different forms and should not be construed as limiting the scope of the appended claims.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., herein to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

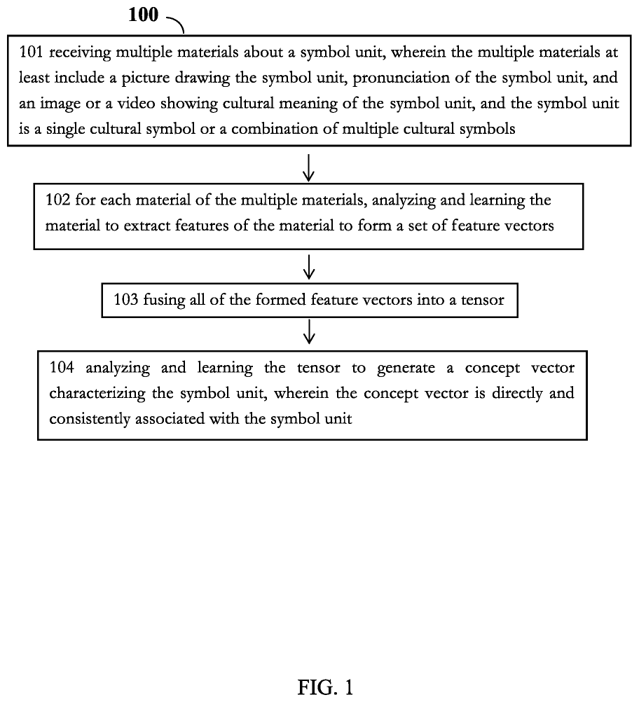

A flowchart of a method 100 for characterizing cultural symbols by using a machine learning model according to the present disclosure is shown in FIG. 1. The method 100 includes: a step 101 of receiving multiple materials about a symbol unit, wherein the multiple materials at least include a picture drawing the symbol unit, pronunciation of the symbol unit, and an image or a video showing cultural meaning of the symbol unit, and the symbol unit is a single cultural symbol or a combination of multiple cultural symbols; a step 102 of, for each material of the multiple materials, analyzing and learning the material to extract features of the material to form a set of feature vectors; a step 103 of fusing all of the formed feature vectors into a tensor; and a step 104 of analyzing and learning the tensor to generate a concept vector characterizing the symbol unit, wherein the concept vector is directly and consistently associated with the symbol unit.

In an embodiment, the tensor enables the machine learning model to infer one or two sets of feature vectors respectively corresponding to one or two materials in a picture drawing the symbol unit, pronunciation of the symbol unit, and an image or a video showing cultural meaning of the symbol unit, in the case that one or more further materials about the symbol unit are received by the machine learning model later, and the one or two materials are missing in the one or more further materials.

In an embodiment, the method 100 further comprises: fusing the concept vector and one or more concept vectors arranged in a specific order to form a further tensor, wherein the one or more concept vectors respectively characterize one or more other symbol units and are generated by the machine learning model, and the arrangement of the symbol unit and the one or more other symbol units in the specific order forms a context having a cultural meaning, and analyzing and learning the further tensor to generate a further concept vector, wherein the further concept vector characterizes the characteristics of the symbol unit itself and the association of the symbol unit with the one or more other symbol units.

In an embodiment, the single cultural symbol is a literal symbol, a mathematical symbol, a logical symbol, a trademark, a flag or a political symbol, and the combination of multiple cultural symbols is a literal word, a literal abbreviation, a mathematical formula or a logical representation.

In an embodiment, the multiple materials further include a description of the cultural meaning of the symbol unit in a dictionary.

In an embodiment, the machine learning model is a deep learning model, a complete autoencoder, a undercomplete autoencoder, and/or a mathematical statistical model.

In an embodiment, the machine learning model is a single model for machine learning or a combination of multiple models for machine learning.

Now, particular embodiments will be described in connection with a Chinese word. It can be understood that, although the embodiments herein are described in connection with a Chinese word, the embodiments can be also applied to other cultural symbols such as hieroglyphs, other literal symbols (e.g., English words), mathematical symbols, logical symbols, trademarks, flags, political symbols, etc. It will be also understood that, although specific terms are used in the embodiments, the embodiments are not limited to those specific terms but may involve all similar terms.

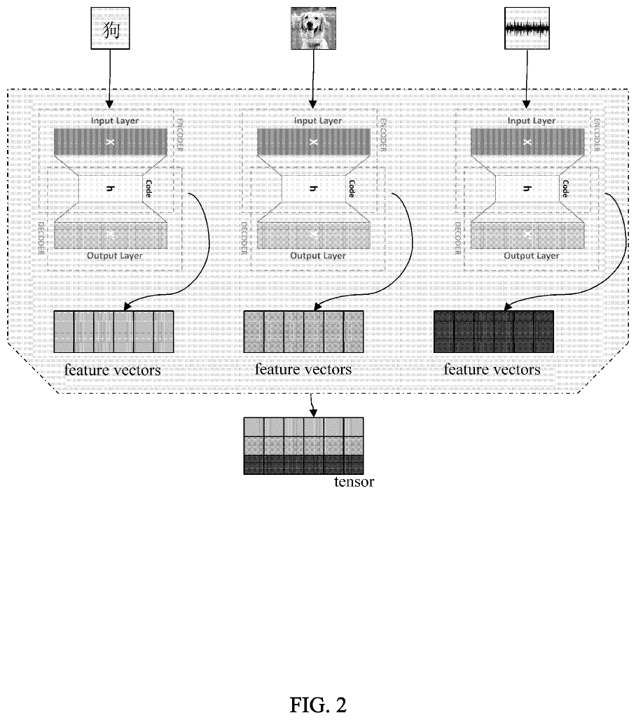

An exemplary processing of the method according to the present disclosure for characterizing a symbol unit is shown in FIGS. 2-6. In the exemplary processing, the symbol unit is a single cultural symbol, in particular, a Chinese word.

As shown in FIG. 2, at first, the machine learning model receives multiple materials about a Chinese word “ [symbol] ”, which means a dog, as the input. According to the present disclosure, the multiple materials should at least include a picture drawing the Chinese word, pronunciation of the Chinese word, and an image or a video showing cultural meaning of the Chinese word. In particular, the multiple materials received by the machine learning model in this example include a picture drawing “ [symbol] ”, pronunciation of the Chinese word, and an image showing a dog. In an embodiment, the multiple materials further include a description of the definition of the Chinese word “ [symbol] ” in a dictionary.

Then, for each material of the multiple materials, the machine learning model analyzes and learns the material to extract features of the material to form a set of feature vectors. In particular, in this example, after the analyzing and learning, the machine learning model extracts features of the picture to form a first set of feature vectors, extracts features of the image to form a second set of feature vectors, and extracts features of the pronunciation to form a third set of feature vectors, as shown in FIG. 2. In an embodiment, the lengths of the three sets of feature vectors are the same. Next, the machine learning model will fuse all of the formed feature vectors into a tensor.

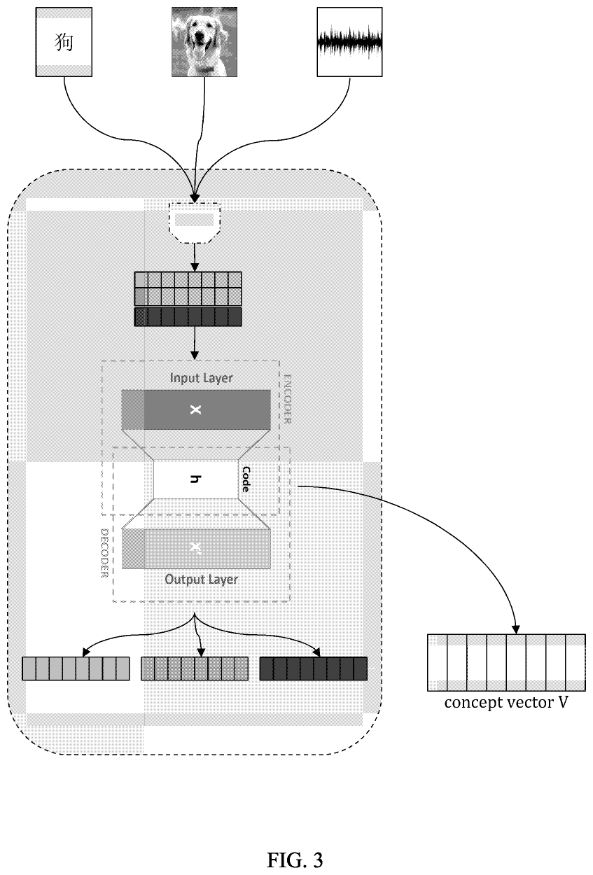

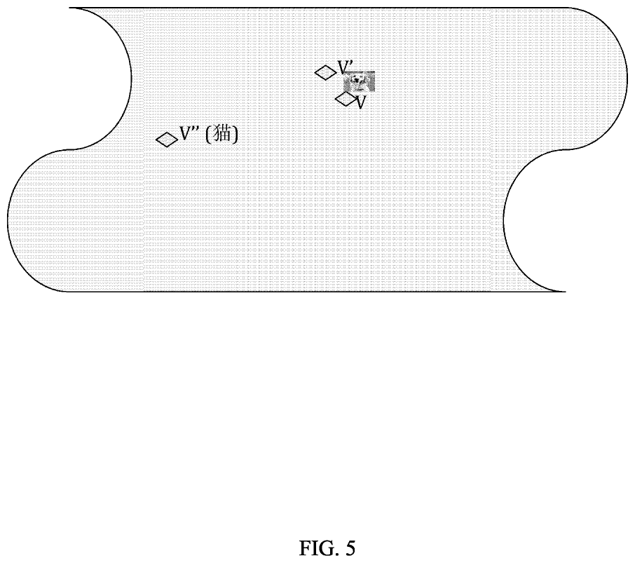

After the tensor is formed, the machine learning model analyzes and learns the tensor to generate a concept vector V characterizing the Chinese word, as shown in FIG. 3. The concept vector is directly and consistently associated with the Chinese word, so that the concept vector is significantly different from other concept vectors characterizing other Chinese words. For example, in a vector space of FIG. 5, the concept vector V is significantly different from a concept vector V″ corresponding to the Chinese word “ [symbol] ”. which means a cat.

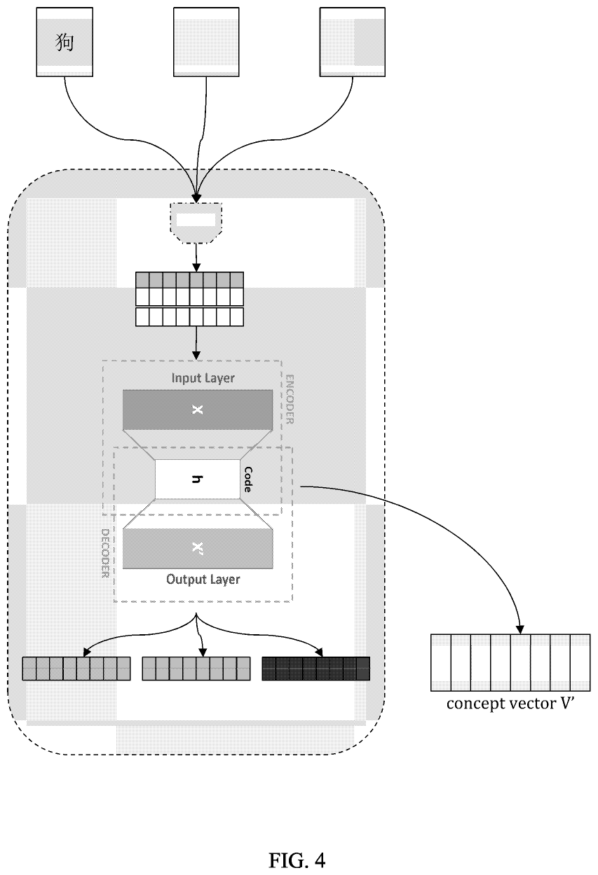

In an embodiment, the machine learning model may receive one or more further materials about the Chinese word “ [symbol] ” later, and the one or more further materials lack one or two materials of a picture drawing “ [symbol] ”, pronunciation of the Chinese word, and an image or a video showing a dog. For example, in FIG. 4, the machine learning model receives only a picture drawing “ [symbol] ” later, without receiving pronunciation of the Chinese word and an image or a video showing a dog. In this embodiment, the tensor may enable the machine learning model to infer one or two sets of feature vectors respectively corresponding to the one or two materials which are missing. For example, in FIG. 4, the tensor (formed in FIG. 2) enables the machine learning model to infer two sets of feature vectors respectively corresponding to pronunciation of the Chinese word and an image showing a dog. In a further embodiment, the machine learning model may fuse all of the feature vectors (including the two inferred sets of feature vectors and the formed set of feature vectors corresponding to the picture in this exemplary processing) into another tensor, which is further used to generate another concept vector V′ characterizing the symbol unit (i.e., the Chinese word “ [symbol] ” in this exemplary processing) as shown in FIG. 4. Said another concept vector is also directly and consistently associated with the symbol unit, so that said another concept vector is significantly different from other concept vectors characterizing other symbol units as well. For example, in the vector space of FIG. 5, said another concept vector V′ is significantly different from the concept vector V″ corresponding to the Chinese word “ [symbol] ”.

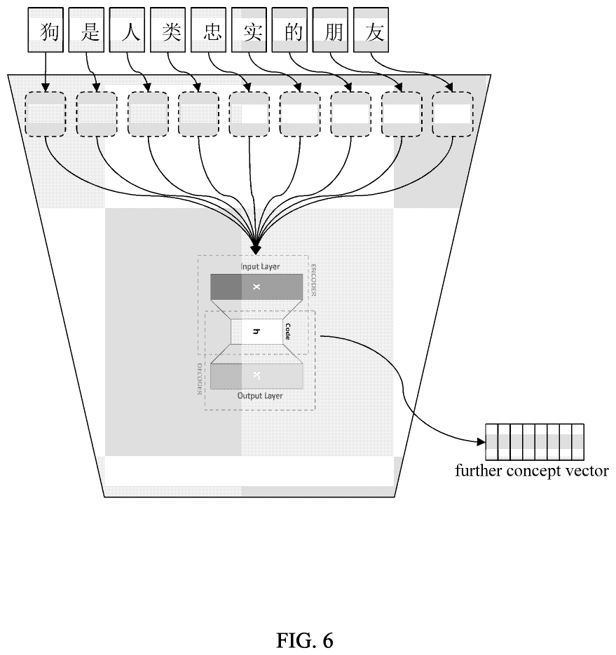

In a cultural symbol system such as texts, symbol units may have contextual and semantic correlations with each other, i.e., an arrangement of two or more symbol units in a specific order may form a context having a cultural meaning. For example, the Chinese word “ [symbol] ” may be arranged with eight Chinese words “ [symbol] ”, “ [symbol] ”, “ [symbol] ”, “ [symbol] ”, “ [symbol] ”, “ [symbol] ”, “ [symbol] ” and “ [symbol] ” in a specific order to form a meaningful sentence. Likewise, for the eight Chinese words, the machine learning model may generate eight concept vectors respectively characterizing those eight Chinese words. In this example, as shown in FIG. 6, the machine learning model may fuse the concept vector corresponding to “ [symbol] ” and the eight concept vectors arranged in the specific order to form a further tensor, and then analyze and learn the further tensor to generate a further concept vector, wherein the further concept vector characterizes the characteristics of the Chinese word “ [symbol] ” itself and its association with those eight Chinese words.

In addition, in some cultural symbol systems like an alphabetical symbol system, the cultural symbol itself (e.g., an English letter) does not have a rich meaning, and the meaning of cultural symbols depends on the combination (e.g., an English word) of the cultural symbols. Hence, in an embodiment, the symbol unit to be characterized by the machine learning model according to the present disclosure is a combination of multiple cultural symbols, instead of a single cultural symbol, and with multiple materials about the combination of multiple cultural symbols being received as input, the machine learning model may also perform the above method according to the present disclosure to generate a concept vector characterizing the combination of multiple cultural symbols.

Further, the single cultural symbol may be not only a literal symbol, but also a mathematical symbol, a logical symbol, a trademark, a flag or a political symbol, and the combination of multiple cultural symbols may be not only a literal word, but a literal abbreviation, a mathematical formula or a logical representation.

Moreover, as described above, the machine learning model may be a deep learning model, a complete autoencoder, a undercomplete autoencoder, and/or a mathematical statistical model, and may refer to a single model for machine learning or a combination of multiple models for machine learning.

It is understood that blocks of the block diagrams and/or flowchart illustrations, and combinations of blocks in the block diagrams and/or flowchart illustrations, may be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

It is also to be understood that the functions/acts noted in the blocks of the flowchart may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Furthermore, the solution of the present disclosure may take the form of a computer program on a memory having computer-usable or computer-readable program code embodied in the medium for use by or in connection with an instruction execution system. In the context of this document, a memory may be any medium that may contain, store, or is adapted to communicate the program for use by or in connection with the instruction execution system, apparatus, or device.

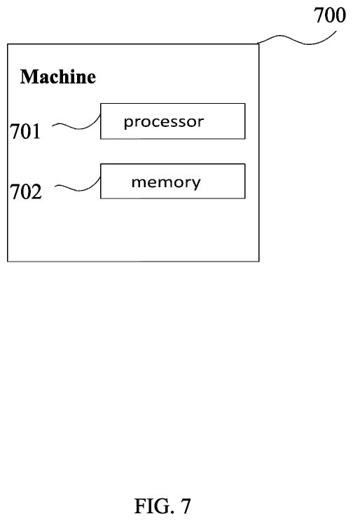

Therefore, the present disclosure also provides a machine 700 including a processor 701 and a memory 702, as shown in FIG. 7. In the machine 700, the memory 702 stores instructions that when executed by the processor 701 cause the machine 700 to perform the method according to the present disclosure described above.

The present disclosure also provides a machine readable medium (not illustrated) having stored thereon instructions that when executed on a machine cause the machine to perform the method according to the present disclosure described above.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

What is claimed is:

1. A method for characterizing cultural symbols by using a machine learning model, including:
receiving multiple materials about a symbol unit, wherein the multiple materials at least include a picture drawing the symbol unit, pronunciation of the symbol unit, and an image or a video showing cultural meaning of the symbol unit, and the symbol unit is a single cultural symbol or a combination of multiple cultural symbols;
for each material of the multiple materials, analyzing and learning the material to extract features of the material to form a set of feature vectors;
fusing all of the formed feature vectors into a tensor; and
analyzing and learning the tensor to generate a concept vector characterizing the symbol unit, wherein the concept vector is directly and consistently associated with the symbol unit.

2. The method of claim 1, wherein the tensor enables the machine learning model to infer one or two sets of feature vectors respectively corresponding to one or two materials in a picture drawing the symbol unit, pronunciation of the symbol unit, and an image or a video showing cultural meaning of the symbol unit, in the case that one or more further materials about the symbol unit are received by the machine learning model later, and the one or two materials are missing in the one or more further materials.

3. The method of claim 1, further comprising:
fusing the concept vector and one or more concept vectors arranged in a specific order to form a further tensor, wherein the one or more concept vectors respectively characterize one or more other symbol units and are generated by the machine learning model, and the arrangement of the symbol unit and the one or more other symbol units in the specific order forms a context having a cultural meaning, and
analyzing and learning the further tensor to generate a further concept vector, wherein the further concept vector characterizes the characteristics of the symbol unit itself and the association of the symbol unit with the one or more other symbol units.

4. The method of claim 1, wherein the single cultural symbol is a literal symbol, a mathematical symbol, a logical symbol, a trademark, a flag or a political symbol, and the combination of multiple cultural symbols is a literal word, a literal abbreviation, a mathematical formula or a logical representation.

5. The method of claim 1, wherein the multiple materials further include a description of the cultural meaning of the symbol unit in a dictionary.

6. The method of claim 1, wherein the machine learning model is a deep learning model, a complete autoencoder, a undercomplete autoencoder, and/or a mathematical statistical model.

7. The method of claim 1, wherein the machine learning model is a single model for machine learning or a combination of multiple models for machine learning.

8. A machine readable medium, having stored thereon instructions, that when executed by a machine, cause the machine to perform the method of claim 1.
